(19) United States
(12) Patent Application Publication
(10) Pub. No.: US 2022/0122050 A1
(43) Pub. Date: Apr. 21, 2022

(54) Systems and Methods for Digital Asset Management

(71) Applicant: Verizon Patent and Licensing Inc., Basking Ridge, NJ (US)

(72) Inventors: Dante J. Pacella, Charles Town, WV (US); Nazneen Khan, Alpharetta, GA (US); Mani Tadayon, Leesburg, VA (US); Allison M. Forgues, Sterling, MA (US)

(21) Appl. No.: 17/074,127

(22) Filed: Oct. 19, 2020

(51) Int. Cl. G06Q 20/12; G06Q 40/04; G06Q 10/10; G06Q 20/36; G06Q 20/38; G06K 19/06

(52) U.S. Cl. CPC G06Q 20/1235; G06Q 40/04; G06Q 10/10; G06Q 30/0204; G06Q 20/3825; G06K 19/06037; G06Q 2220/10; G06Q 20/3674

(57) ABSTRACT

An exemplary method includes a digital asset management system sending a non-fungible digital asset from a first computer system to a second computer system. The first computer system and the second computer system may be included in a plurality of computer systems configured to form a distributed record configured to track ownership of non-fungible digital assets. The digital asset management system may further record, in the distributed record, information indicative of the sending of the non-fungible digital asset to the second computer system. A user account associated with the first computer system may retain partial ownership in the non-fungible digital asset after the sending of the non-fungible digital asset to the second computer system

### BACKGROUND INFORMATION

Advances in digital asset management have resulted in different ways that digital assets may be transferred between users of computer systems. For example, a user of a computing device (e.g., a smartphone, a tablet computer, etc.) may receive a digital asset (e.g., a cryptocurrency token) by way of an airdrop to an account (e.g., a cryptocurrency wallet) associated with the user.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary digital asset management system according to principles described herein.

FIG. 2 illustrates an exemplary implementation of the digital asset management system of FIG. 1 according to principles described herein.

FIG. 3 illustrates an exemplary digital asset specification including a plurality of ownership functions that may be implemented according to principles described herein.

FIGS. 4-7 illustrate exemplary flow charts showing various operations that may be performed according to principles described herein.

FIG. 8 illustrates an exemplary ownership transfer process of a digital asset according to principles described herein.

FIGS. 9-10 illustrate exemplary methods for digital asset management according to principles described herein.

FIG. 11 illustrates an exemplary computing device according to principles described herein.

### DETAILED DESCRIPTION OF PREFERRED EMBODIMENTS

Systems and methods for digital asset management are described herein. For example, an exemplary digital asset management system may facilitate ownership transfer and/or restricted shared use of a non-fungible digital asset between users of computer systems.

In certain examples, for instance, an exemplary method may include sending, by a digital asset management system, a non-fungible digital asset from a first computer system to a second computer system. The first computer system and the second computer system may be included in a plurality of computer systems configured to form a distributed record configured to track ownership of non-fungible digital assets. The method may further include recording, by the digital asset management system in the distributed record, information indicative of the sending of the non-fungible digital asset to the second computer system. The sending of the non-fungible digital asset from the first computer system to the second computer system may be performed such that a user account associated with the first computer system retains partial ownership in the non-fungible digital asset after the sending of the non-fungible digital asset to the second computer system.

In certain examples, for instance, an additional exemplary method may include receiving, by a digital asset management system, a non-fungible digital asset sent from a first computer system to a second computer system. The first computer system and the second computer system may be included in a plurality of computer systems configured to form a distributed record configured to track ownership of non-fungible digital assets. The method may further include recording, by the digital asset management system in the distributed record, information indicative of the receiving of the non-fungible digital asset sent from the first computer system to the second computer system. A user account associated with the first computer system may retain partial ownership in the non-fungible digital asset after the receiving of the non-fungible digital asset by the digital asset management system.

As used herein, “partial ownership” of a non-fungible digital asset may refer to any form of ownership other than full unrestricted ownership of the non-fungible digital asset. As will be described further herein, partial ownership may include ownership of a non-fungible digital asset subject to certain restrictions (e.g., restrictions associated with use, sale, etc.). In certain examples, partial ownership of a non-fungible digital asset may include certain rights (e.g., rights to proceeds upon sale) being granted to an entity (e.g., a charity) while restricted ownership of the non-fungible digital asset is retained by another entity.

As used herein, a “non-fungible digital asset” may include any digital asset that is not interchangeable with other digital assets. For example, a non-fungible digital asset may include a digital token, a still image (e.g., a digital trading card, a digital poster, etc.), a digital signature or identifier, augmented reality content, a live photo, an audio file, a video file, and/or any other suitable non-fungible digital asset or combination of non-fungible digital assets. In certain examples, a non-fungible digital asset may be unique. The non-fungibility of a digital asset may be due to any suitable attribute of the digital asset. For example, the non-fungibility of a digital asset may be due to intrinsic attributes of the digital asset that distinguish the digital asset from other digital assets so as to make the digital assets not readily interchangeable with each other. For example, a first live photo of a first person (e.g., a celebrity, an athlete, etc.) may be intrinsically visually different from and thus not readily interchangeable with a second live photo of a second person that is different than the first person.

In certain examples, a non-fungible digital asset may be unique with a certain number of them being available (e.g., a certain number of the same digital trading card may be available). Such non-fungible digital assets may be considered as being part of the same series and may be implemented in any suitable manner.

As will be described further herein, non-fungible digital assets such as those described herein may be subject to restrictions that govern ownership, transfer, use, and/or sharing of the non-fungible digital assets with others. In certain examples, such restrictions may define restricted ownership (also referred to herein as fractional ownership) of a non-fungible digital asset where there are two or more owners that share the whole non-fungible digital asset subject to the restrictions.

Non-fungible digital assets such as those described herein may be distributed and/or shared in any suitable manner. For example, non-fungible digital assets may be distributed or shared by way of delivery (e.g., a push notification) to a computing device in the form of a text message, an email, etc. In certain examples, scannable codes (e.g., QR codes) may be used to facilitate sharing non-fungible digital assets between users. In certain implementations, non-fungible digital assets such as those described herein may be distributed by way of an airdrop to one or more computing devices.

To illustrate an example, an operator of a venue (e.g., a sporting venue) may use a digital asset management system to facilitate sending a non-fungible digital asset in the form of a collectable digital item (e.g., a digital sports trading card of athlete) to a spectator in attendance at the venue. The digital asset management system may send the collectible digital item in any suitable manner (e.g., by way of an airdrop of the non-fungible digital asset) from a first computer system to a second computer system associated with the spectator in attendance at the venue. The digital asset management system may record information indicative of the sending of the collectable digital item in a distributed record (e.g., a distributed ledger implemented by blockchain). In certain examples, a user account (e.g., a digital asset wallet) of the spectator that is configured to receive the collectable digital item may be inactive. That is, the user account may not be used or otherwise may be inaccessible (e.g., due to a loss of a digital access key) by the spectator, which would result in the collectible digital item being lost. To prevent this, the sending of the collectable digital item to the second computer system may be performed in such a manner that a user account (e.g., a digital asset wallet) associated with the first computer system may retain partial ownership in the collectable digital item after the sending of the collectable digital item to the second computer system. In such an example, the collectible digital item may be subject to a restriction that specifies that full ownership of the collectible digital asset does not transfer to the user account of the spectator unless a predefined condition (e.g., the user performing an action to accept receipt of the collectible digital asset) is satisfied. If the predefined condition is satisfied, full ownership of the collectable digital asset may transfer to the user account of the spectator of the sporting event. However, if the predefined condition is not satisfied, then full ownership of the collectible digital asset may revert back to the user account associated with the first computer system.

Various advantages and benefits are associated with the systems and methods for digital asset management described herein. For example, systems and methods such as those described herein may prevent digital assets from being lost when they are transmitted to user accounts that are unused or otherwise inaccessible. In addition, systems and methods such as those described herein may facilitate restricted shared access and/or augmentation of digital assets such as non-fungible digital assets. Such augmentation may beneficially increase value of the non-fungible digital assets. Moreover, systems and methods such as those described herein may facilitate generating analytics information, which may be used to track popularity, ownership, and/or use of digital assets in different market segments. These and other benefits that may be provided by systems and methods described herein will be evident from the disclosure that follows.

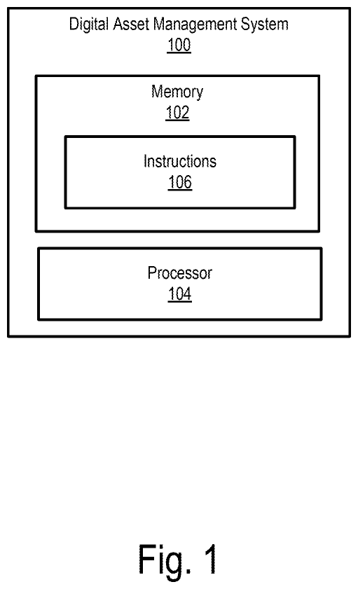

FIG. 1 illustrates an exemplary digital asset management system 100 (“system 100”). As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device. In other examples, memory 102 and/or processor 104 may be distributed between multiple devices and/or multiple locations as may serve a particular implementation. An illustrative implementation of system 100 is described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store data representative of digital assets such as non-fungible digital assets, analytical information associated with use of digital assets, information regarding augmentation of digital assets, information defining restrictions associated with transferring ownership and/or sharing of digital assets, notifications, graphics, and/or any other suitable data.

Processor 104 may be configured to perform (e.g., execute instructions 106 stored in memory 102 to perform) various processing operations associated with digital asset management. For example, processor 104 may send a non-fungible asset from a first computer system to a second computer system; and may record, in a distributed record, information indicative of the sending of the non-fungible digital asset to the second computer system. These and other operations that may be performed by processor 104 are described herein.

System 100 (e.g., processor 104) may be configured to provide any suitable service and/or feature that may be associated with digital assets as may serve a particular implementation. For example, system 100 may be configured to manage ownership transfer of digital assets, sharing of digital assets, augmentation of digital assets, use of digital assets, and/or provide any other suitable service and/or feature that may facilitate management of one or more digital assets.

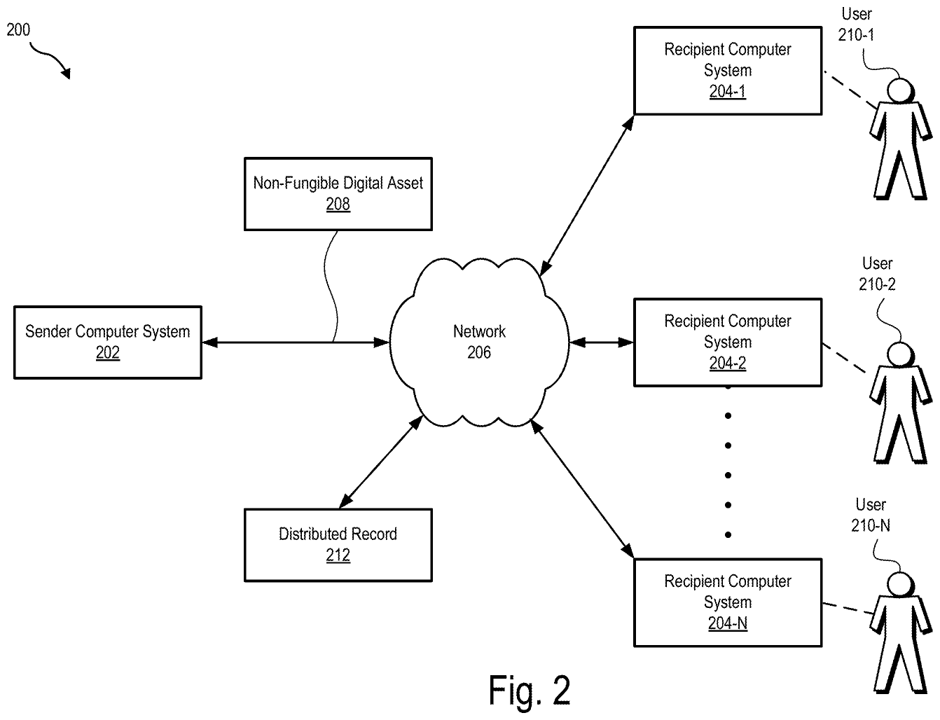

System 100 may be implemented in any suitable manner as may serve a particular application. FIG. 2 shows an exemplary implementation 200 in which system 100 may be provided in certain examples. As shown in FIG. 2, implementation 200 includes a sender computer system 202 that is communicatively connected to a plurality of recipient computer systems 204 (e.g., recipient computer systems 204-1 through 204-N) by way of a network 206. Sender computer system 202 and recipient computer systems 204 may be implemented by any suitable computing device or combination of computing devices as may serve a particular implementation. For example, sender computer system 202 and/or recipient computer systems 204 may be implemented by desktop computers, laptop computers, smartphones, and/or any other suitable type of computing device. System 100 may be implemented by either sender computer system 202 or recipient computer 204. Alternatively, system 100 may be distributed across sender computer system 202, recipient computer systems 204, and/or any other suitable computer system.

Sender computer system 202 and recipient computer systems 204 may communicate using any communication platforms and technologies suitable for transporting data and/or communication signals, including known communication technologies, devices, media, and protocols supportive of remote communications, examples of which include, but are not limited to, data transmission media, communications devices, and data transmission protocols.

Network 206 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, live television transmission networks, and any other networks capable of carrying media content, data, and/or communications signals between sender computer system 202 and recipient computer systems 204. Communications between sender computer system 202 and recipient computer systems 204 may be transported using any one of the above-listed networks, or any combination or sub-combination of the above-listed networks. Alternatively, sender computer system 202 and recipient computer systems 204 may communicate in another way such as by one or more direct connections between sender computer system 202 and recipient computer systems 204.

As shown in FIG. 2, system 100 may send a non-fungible digital asset 208 by way of network 206 to one or more of recipient computer systems 204 that are each associated with a user 210 (e.g., users 210-1 through 210-N). System 100 may send non-fungible digital asset 208 by way of network 206 in any suitable manner. For example, system 100 may use network 206 to airdrop a separate non-fungible digital asset 208 to each of one or more of recipient computer systems 204.

System 100 may be configured to record information associated with transfer of ownership, sharing, augmentation, etc. of a non-fungible digital asset in a distributed record 212. To that end, sender computer system 202 and recipient computer systems 204 may be configured to form distributed record 212 to facilitate tracking ownership and/or use of non-fungible digital assets. Distributed record 212 may correspond to any suitable type of distributed record as may serve a particular implementation. For example, distributed record 212 may correspond to a distributed ledger that is implemented by blockchain in certain examples. Although distributed record 212 is shown as being separate from sender computer system 202 and recipient computer systems 204, it is understood that a copy of distributed record 212 may be stored in any suitable storage device associated with either sender computer system 202, recipient computer systems 204, and/or any other suitable computer system. Alternatively, distributed record 212 may be distributed across sender computer system 202, recipient computer systems 204, and/or any other suitable computer system.

In certain examples, non-fungible digital asset 208 may be subject to a digital asset specification that defines a plurality of ownership functions associated with non-fungible digital asset. Such a digital asset specification may be implemented in any suitable manner as may serve a particular implementation. For example, such a digital asset specification may be implemented by a digital wallet application operating on sender computer system 202 and/or recipient computer systems 204. Such a digital wallet application may be configured to (e.g., programmed to) operate in accordance with the ownership functions defined in the digital asset specification. Alternatively, such a digital asset specification may be implemented in the form of a smart contract that is recorded in distributed record 212 and that defines a transaction protocol that automatically executes certain operations based on the plurality of ownership functions defined in the digital asset specification. Such a smart contract may be implemented by any suitable cryptocurrency framework as may serve a particular implementation. For example, Ethereum may be used in certain examples to implement a digital asset specification that defines a plurality of ownership functions.

In certain examples, the plurality of ownership functions defined in a digital asset specification such as described herein may be implemented as an extension to a digital asset protocol. For example, the plurality of ownership functions may be implemented as an extension to an ERC-721 non-fungible token protocol, an extension to an ERC-1155 multi token protocol, or an extension to any other suitable digital asset protocol.

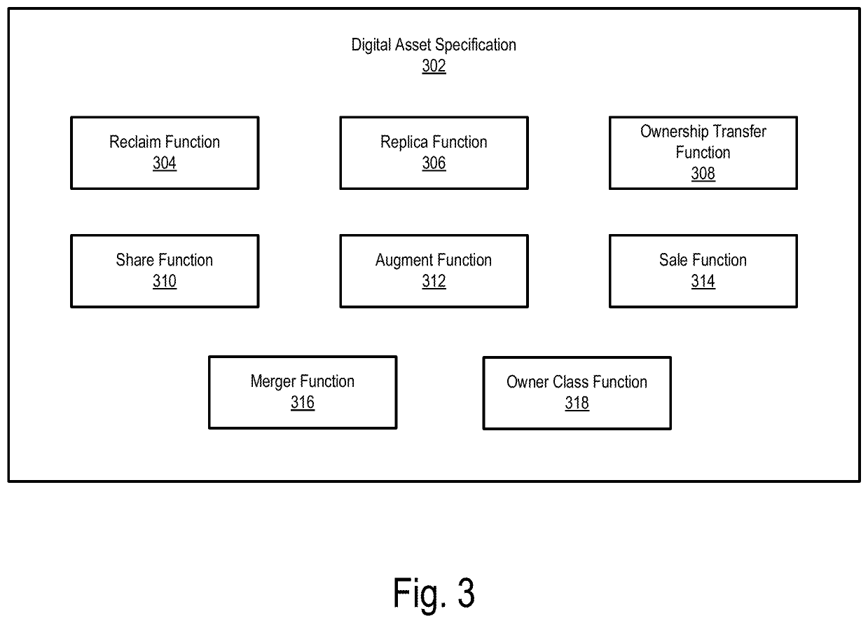

The plurality of ownership functions may include any suitable type of function that may facilitate digital asset management. To illustrate, FIG. 3 shows an exemplary digital asset specification 302 that includes a plurality of ownership functions that may be implemented according to principles described herein. As shown in FIG. 3, digital asset specification 302 may include, a reclaim function 304, a replica function 306, an ownership transfer function 308, a share function 310, an augment function 312, a sale function 314, a merger function 316, an owner class function 318, and/or any other suitable function. Each of these different exemplary ownership functions will now be described in further detail.

Reclaim function 304 included in the plurality of ownership functions may specify that full ownership of a non-fungible digital asset reverts to a user account associated with a sender computer system (e.g., sender computer system 202) upon satisfaction of a predefined condition. With reclaim function 304, it is possible to avoid loss of the non-fungible digital asset if the non-fungible digital asset is sent to an inactive user account associated with a recipient computer system (e.g., recipient computer system 204-1).

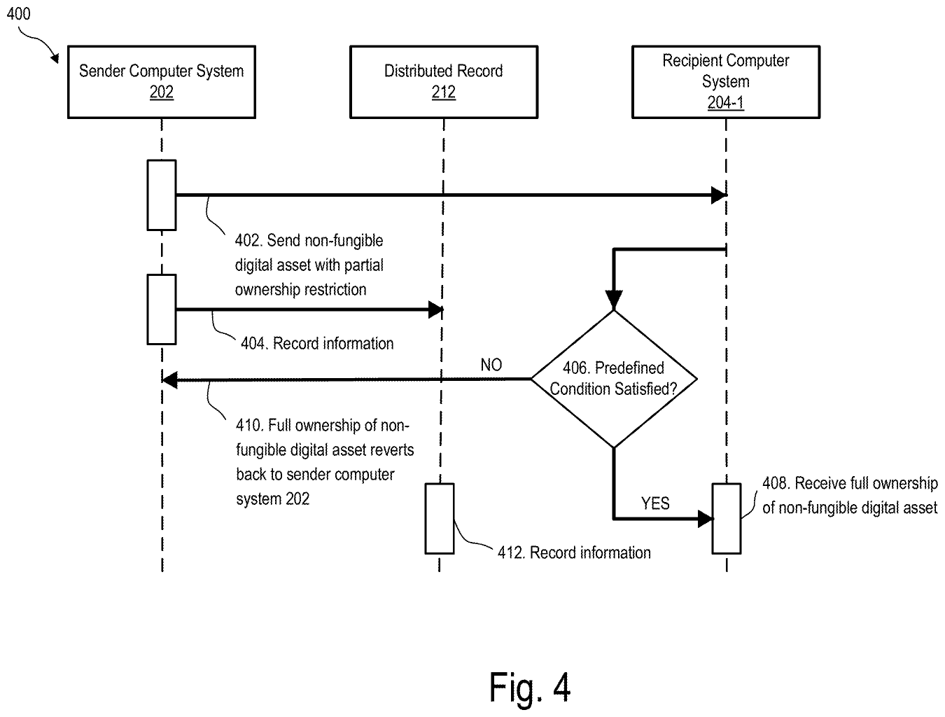

FIG. 4 is a flow diagram 400 that depicts exemplary operations that may be performed by system 100 according to reclaim function 304 included in digital asset specification 302. At operation 402, sender computer system 202 may send a non-fungible digital asset (e.g., non-fungible digital asset 208) to recipient computer system 204-1 with a partial ownership restriction. The partial ownership restriction may specify that recipient computer system 204-1 only receives full ownership of the non-fungible digital asset upon satisfaction of a predefined condition. Such a predefined condition may correspond to any suitable condition that may be used to trigger transfer of the full ownership of the non-fungible digital asset to a user account associated with recipient computer system 204-1. For example, the predefined condition may require that user 210-1 perform any suitable action by way of a user interface of recipient computer system 204-1 to actively accept receipt of the non-fungible digital asset. Additionally or alternatively, the predefined condition may include expiration of a predefined time period in which user 210-1 of recipient computer system 204-1 is required to accept receipt of the non-fungible digital asset.

Prior to the predefined condition being satisfied, a user account associated with sender computer system 202 may retain partial ownership of the non-fungible digital asset after sending the non-fungible digital asset to recipient computer system 204-1. Sender computer system 202 may retain any suitable amount of partial ownership of the non-fungible digital asset as may serve a particular implementation. For example, in certain implementations there may be a 50/50 ownership split between sender computer system 202 and recipient computer system 204-1 as a result of operation 302. In certain alternative implementations, sender computer system 202 may retain partial ownership of the non-fungible digital asset based on one or more restrictions, such as those described herein, that govern ownership transfer of the non-fungible digital asset.

At operation 404, sender computer system 202 may record information indicative of the sending of the non-fungible digital asset in distributed record 212. In certain examples, the recording of the information in distributed record 212 may include recording that a user account associated with sender computer system 202 owns a first part of the non-fungible digital asset and an additional user account associated with recipient computer system 204-1 owns a second part of the non-fungible digital asset. The first part and the second part may include any suitable portion of ownership of the non-fungible digital asset as may serve a particular implementation. For example, the first part may be equivalent to fifty percent ownership of the non-fungible digital asset and the second part may be equivalent to the remaining fifty percent ownership, though the ownership percentages are not limited to those found in this example.

While the user account associated with sender computer system 202 owns the first part of the non-fungible digital asset and the additional user account associated with recipient computer system 204-1 owns the second part of the non-fungible digital asset, the non-fungible digital asset may be considered as being in a pending activation state. During such a pending activation state, the non-fungible digital asset may be subject to certain restrictions associated with the split ownership of the non-fungible digital asset. For example, during the pending activation state, approval for transfer of ownership of the non-fungible digital asset to a third party may be required by both a user of sender computer system 202 and user 210-1 of the recipient computer system 204-1. Additionally or alternatively, the non-fungible digital asset may be subject to a modification restriction, and/or any other suitable restriction during the pending activation state.

During the pending activation state, full ownership transfer of the non-fungible digital asset to a user account associated with recipient computer system 204-1 may depend on satisfaction of a predefined condition. Accordingly, at operation 406, system 100 may determine whether the predefined condition is satisfied. If the answer at operation 406 is “YES,” a user account associated with recipient computer system 204-1 may receive full ownership of the non-fungible digital asset at operation 408. For example, system 100 may determine that the predefined condition is satisfied if user 210-1 accepts receipt of the non-fungible digital asset within a predefined time period.

If the answer at operation 406 is “NO,” according to reclaim function 304, full ownership of the non-fungible digital asset may revert back to sender computer system 202 at operation 410. In certain examples, full ownership of the non-fungible digital asset may automatically revert back to sender computer system 202 if the predefined condition is not satisfied. Alternatively, a user of sender computer system 202 may perform any suitable action to facilitate a user account associated with sender computer system 202 reclaiming ownership of the non-fungible digital asset.

At operation 412, system 100 is configured to record information associated with ownership of the non-fungible digital asset in distributed record 212. For example, if the answer at operation 406 is “YES,” system 100 may record information in distributed record 212 indicating that the predefined condition was satisfied and that full ownership of the non-fungible digital asset was transferred to recipient computer system 204-1. Alternatively, if the answer at operation 406 is “NO,” system 100 may record information in distributed record 212 indicating that the predefined condition was not satisfied and that full ownership of the non-fungible digital asset reverted back to a user account associated with sender computer system 202.

Replica function 306 may specify various parameters associated with creating replicas of a non-fungible digital asset for distribution. Replica function 306 may be implemented in any suitable manner as may serve a particular implementation. For example, a prime non-fungible digital asset may be generated that is a unique non-fungible digital asset and that has a unique prime identifier and any other suitable information (e.g., metadata). The prime non-fungible digital asset may then be replicated in any suitable manner according to replica function 306 to generate any suitable number of replicas of the non-fungible digital asset. The number of replicas may be selected based on the desired rarity for the series of non-fungible digital assets. Each replica may have a unique identifier so that each replica may be independently owned and transferred between others. In such examples, information (e.g., a series identifier) indicating that the replicated non-fungible digital assets belong to a limited series or set of the same non-fungible digital asset may be recorded in a distributed record (e.g., a distributed ledger implemented by blockchain). The information stored in the distributed record may be used by owners to verify that the non-fungible digital assets are part of the series or set of the same non-fungible digital asset.

To illustrate an example, an operator of a concert venue may use system 100 to send (e.g., by way of an airdrop) a non-fungible digital asset to the first one hundred attendees of a concert that have a digital wallet application downloaded to their respective mobile computing devices (e.g., smartphones). System 100 may implement replica function 306 of digital asset specification 302 in any suitable manner such as described herein to create 100 replicas of the non-fungible digital asset to be distributed to the first one hundred attendees. The non-fungible digital asset in such an example may be in the form of a collectable screen saver depicting a band performing at the concert. System 100 may record, in distributed record 212, information indicative of the sending of the collectable screen saver to each of the mobile computing devices associated with the first one hundred attendees. The sending of the collectable screen saver to the first one hundred attendees may be performed by system 100 such that a digital wallet application associated with the operator of the concert venue may retain partial ownership in each of the collectable screen savers sent to the first one hundred attendees. A first subset of the first one hundred attendees may accept receipt of the collectable screen saver by way of a user input provided in a user interface of the mobile computing devices. In response, system 100 may transfer full ownership of the collectable screen saver to each of the attendees included in the first subset of attendees. However, a second subset of the first one hundred attendees may not accept receipt of the collectable screen saver within a predefined amount of time. In response, the digital asset wallet associated with the operator of the concert venue may reclaim full ownership of collectable screen savers that were sent to the second subset of the attendees. The operator of the concert venue may then reuse the reclaimed collectable screen savers in any suitable manner. For example, the operator of the concert venue may use system 100 to send the reclaimed collectable screen savers to additional attendees of the concert. Alternatively, the reclaimed collectable screen savers may be donated to charity, auctioned, used as raffle prizes, provided as part of an incentive for registration with a service, etc.

Ownership transfer function 308 included in the plurality of ownership functions may specify that full ownership of a non-fungible digital asset is transferred to a user account associated with an additional computer system upon satisfaction of a predefined condition (as implemented, for example, by a smart contract). For example, operation 406 shown in FIG. 4 may be governed by ownership transfer function 308 to transfer full ownership of the non-fungible digital asset to the user account associated with recipient computer system 204-1 upon satisfaction of the predefined condition. With ownership transfer function 308, the predefined condition may include acceptance of receipt of the non-fungible digital asset. For example, a user of recipient computer system 204-1 may be required to provide any suitable user input by way of a user interface of recipient computer system 204-1 to accept receipt of the non-fungible digital asset. To that end, system 100 may be configured to detect the user input accepting receipt of the non-fungible digital asset. In response to the detected user input, system 100 may instruct a user account associated with recipient computer system 204-1 to receive full ownership of the non-fungible digital asset.

Share function 310 included in the plurality of ownership functions may facilitate sharing a non-fungible digital asset with a third party. Share function 310 may specify one or more use restrictions associated with the shared use of the non-fungible digital asset. For example, such use restrictions may include, but are not limited to, time restrictions for viewing and/or accessing the non-fungible digital asset, ownership transfer restrictions, modification restrictions, and/or any other suitable use restriction. With share function 310, there may be a main owner of the non-fungible digital asset and one or more partial owners that have restricted ownership. Share function 310 may beneficially permit the main owner to share a non-fungible digital asset with one or more partial owners without having to worry that the one or more partial owners will modify the non-fungible digital asset and/or transfer the non-fungible digital asset to a third party.

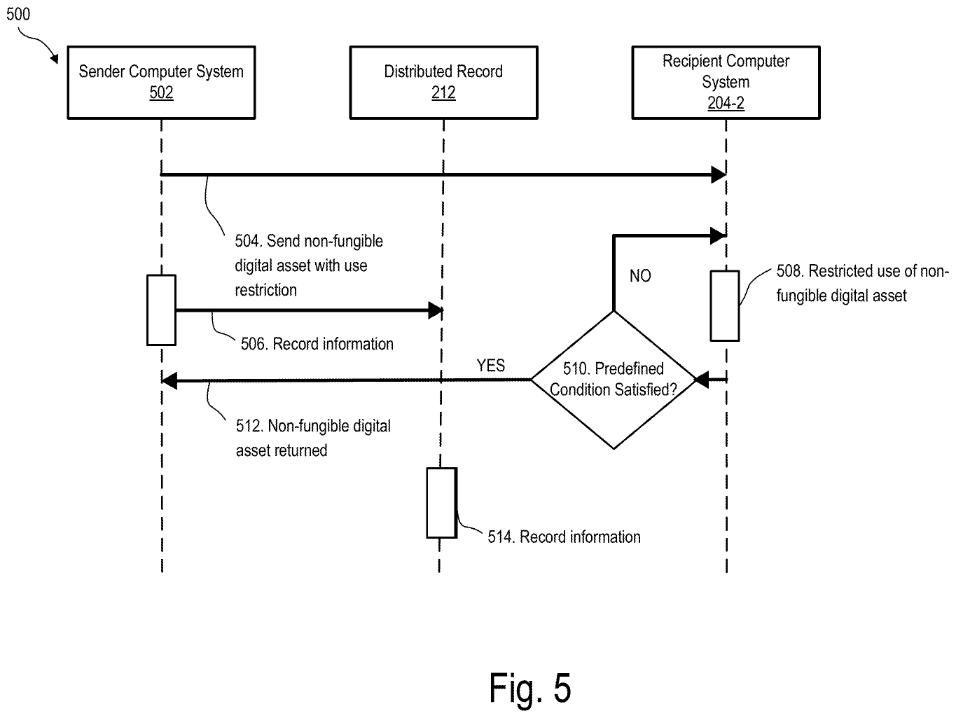

FIG. 5 is a flow diagram 500 that depicts exemplary operations that may be performed by system 100 in conjunction with share function 310 in digital asset specification 302. As shown in FIG. 5, at operation 504, a sender computer system 502 may send a non-fungible digital asset with a use restriction to recipient computer system 204-2. In certain examples, sender computer system 502 may correspond to sender computer system 202. In certain alternative examples, sender computer system 502 may correspond to recipient computer system 204-1 that received the non-fungible digital asset from sender computer system 202. Operation 504 may be performed in any suitable manner such as described herein.

At operation 506, sender computer system 502 may record information indicating the restricted use associated with sending of the non-fungible digital asset to recipient computer system 204-2. Operation 506 may be performed in any suitable manner such as described herein.

At operation 508, user 210-2 may have restricted use access to the non-fungible digital asset by way of recipient computer system 204-2. For example, user 210-2 may be able to view the non-fungible digital asset for a predetermined amount of time but may be restricted from transferring the non-fungible digital asset to a third party and/or modifying the non-fungible digital asset.

At operation 510, system 100 may determine whether a predefined condition associated with the restricted use of the non-fungible digital asset has been satisfied. If the answer at operation 510 is “NO,” the flow reverts back to before operation 508 and user 210-2 may continue to access and/or view the non-fungible digital asset by way of recipient computer system 204-2. For example, if a predefined amount of time has not expired, user 210-2 may continue to access and/or view the non-fungible digital asset.

If the answer at operation 510 is “YES,” system 100 may return the non-fungible digital asset to sender computer system 502 at operation 512.

At operation 514, system 100 may record information in distributed record 212 indicative of the ending of the restricted use of the non-fungible digital asset by computer system 204-1 and the return of the non-fungible digital asset to sender computer system 502.

To illustrate an example in which share function 310 may be implemented, a non-fungible digital asset may correspond to a digital poster that depicts an athlete at a sporting event. Such a digital poster may have been sent (e.g., airdropped) in any suitable manner such as described herein to a user of a computer system while the user was at the sporting event as a gift or a promotion given to spectators at the sporting event. After the user receives the digital poster, the user may want to share the digital poster with one or more friends and/or family. In such an example, share function 310 may facilitate system 100 providing restricted use sharing of the digital poster with the one or more friends and/or family of the user according to operations similar to those depicted in FIG. 5. Accordingly, the user may be able to selectively share partial ownership of the digital poster with the one or more friends and/or family subject to certain restrictions such as a time restriction. A user account of the user may then receive full ownership of the digital poster back after, for example, a predefined time period expires.

In certain examples, share function 310 may include providing indicators and/or notifications to a partial owner that indicate the restricted use and/or partial ownership of a shared non-fungible digital asset. For example, a shared digital poster may be provided for display in a graphical user interface together with an indicator in the form of a lock icon, a watermark, and/or any other suitable indicator that may inform a partial owner that they are merely sharing the non-fungible digital asset and do not own the non-fungible digital asset. Additionally or alternatively, a timer indicator or graphic may be provided for display together with the shared digital poster to indicate how much time remains to view the shared digital poster.

In certain examples, a main owner of a non-fungible digital asset may transfer full ownership of the non-fungible digital asset to a third party while the non-fungible digital asset is currently shared with one or more other users. In such an example, the shared access by the one or more other users may be cut short (e.g., prior to a predefined condition being satisfied) in response to the transfer of the full ownership of the non-fungible digital asset to the third party. Augment function 312 included in the plurality of ownership functions may specify use restrictions and/or modification parameters that permit augmentation of a non-fungible digital asset. Augment function 312 may facilitate any suitable modifications to a non-fungible digital asset that may increase the monetary value and/or desirability of the non-fungible digital asset.

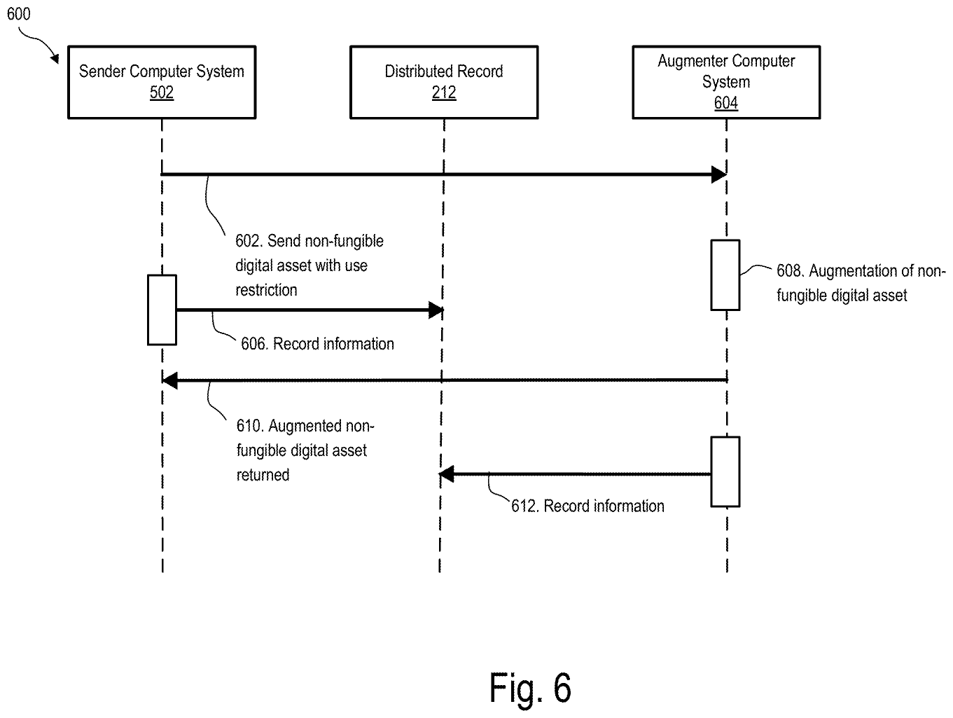

FIG. 6 is a flow diagram 600 that depicts exemplary operations that may be performed by system 100 to augment a non-fungible digital asset. As shown in FIG. 6, at operation 602, sender computer system 502 sends a non-fungible digital asset with a use restriction to an augmenter computer system 604. The use restriction may include an ownership transfer restriction that prevents augmenter computer system 604 from transferring ownership of the non-fungible digital asset to a third party. Additionally or alternatively, the use restriction may prevent modification of the non-fungible digital asset in an manner other than is specified by augment function 312.

At operation 606, sender computer system 502 is configured to record information in distributed record 212 indicative of the sending of the non-fungible digital asset to augmenter computer system. Operation 606 may be performed in any suitable manner.

At operation 608, augmenter computer system 604 may augment the non-fungible digital asset based on a modification parameter specified by augment function 312. Operation 608 may be performed in any suitable manner. For example, an augmentation performed at operation 608 may include adding graphics, effects, one or more digital signatures, etc. to the non-fungible digital asset. Such augmentations may beneficially increase the monetary value of the non-fungible digital asset and/or make the non-fungible digital asset more collectable and/or desirable.

In certain examples, augment function 312 may facilitate augmenting a non-fungible digital asset by combining a semi-fungible digital asset with the non-fungible digital asset. To illustrate an example, continuing with the example described above, the user that received the digital poster of the athlete at the sporting event may want to have the athlete depicted in the digital poster digitally sign the digital poster. In such an example, augment function 312 may be used to send the digital poster to a computer system associated with the athlete to facilitate the athlete augmenting the digital poster with a signature token, which may be considered as a semi-fungible digital asset. The augmenting of the digital poster with the signature token may include merging the digital poster with the signature token such that they are integrated in a digital asset chain stored in distributed record 212.

In such an example, the digital signature may be provided for display with the digital poster in any suitable manner. For example, the digital signature may be overlaid over a portion of the digital poster. Alternatively, the signature may be provided adjacent to the digital poster.

In certain examples, augment function 312 may facilitate augmenting a non-fungible digital asset by combining a plurality of different semi-fungible digital assets with the non-fungible digital asset. For example, the digital poster described above may depict a plurality of different athletes. In such example, a signature token for each of the athletes depicted in the digital poster may be combined with the digital poster.

In certain examples, augment function 312 may facilitate merging or combining a non-fungible digital asset with another digital asset such that the other digital asset is consumed. Such merging may be subject to merger function 316 included in digital asset specification 302. Merger function 316 may specify that assets of a non-fungible digital asset are to be transferred to the other non-fungible digital asset. In such examples, information documenting the merger of the first non-fungible digital asset with the second non-fungible digital asset may be recorded in a distributed record. Such information may be recorded in the distributed record in any suitable format such as by adding a merged data field to metadata associated with the first non-fungible digital asset. In certain examples, the merged data field may be implemented as an array to facilitate multiple digital asset mergers with the first non-fungible digital asset. To illustrate an example, continuing with the example described above, the semi-fungible digital asset used by the athlete to sign the digital poster may, according to merger function 316, result in the semi-fungible digital asset being consumed such that the assets (e.g., the signature) are transferred to the digital poster.

At operation 610, the augmented non-fungible digital asset may be returned to sender computer system 502. Operation 610 may be performed in any suitable manner.

In certain examples, an augmentation may be selectively viewable together with a non-fungible digital asset after augmentation. For example, when the augmentation includes a signature provided with a digital poster, system 100 may facilitate a user associated with sender computing system 502 turning the signature on or off such that the user may view the digital poster in any suitable manner together with the signature or without the signature in a graphical user interface. In certain alternative implementations, the digital poster may only be viewed together with the signature after augmentation.

Sale function 314 included in the plurality of ownership functions may facilitate a user selling a non-fungible digital asset to a third party. For example, after a user account associated with a computer system (e.g., recipient computer system 204-1) receives a non-fungible digital asset (e.g., by way of an airdrop), a user of the computer system may want to sell the non-fungible digital asset to another user. Sale function 314 may facilitate a user selling the non-fungible digital asset to another user in any suitable manner. For example, through sale function 314, system 100 may provide one or more graphical user interface views for display to facilitate a transaction between a selling user and a buying user. Such graphical user interface views may facilitate negotiation of a price and/or payment for the non-fungible digital asset. In certain examples, sale function 314 may define one or more ownership restrictions associated with transferring ownership of the non-fungible digital asset to the buying user. For example, sale function 314 may include a shared ownership restriction that allows the buying user to have restricted access to the non-fungible digital asset. Such restricted access may allow the buying user to, for example, view and/or access the non-fungible digital asset. However, the shared ownership restriction may restrict the buying user from transferring ownership of the non-fungible digital asset to a third party and/or modifying the non-fungible digital asset until an agreed upon payment for the non-fungible digital asset has been received by the selling user.

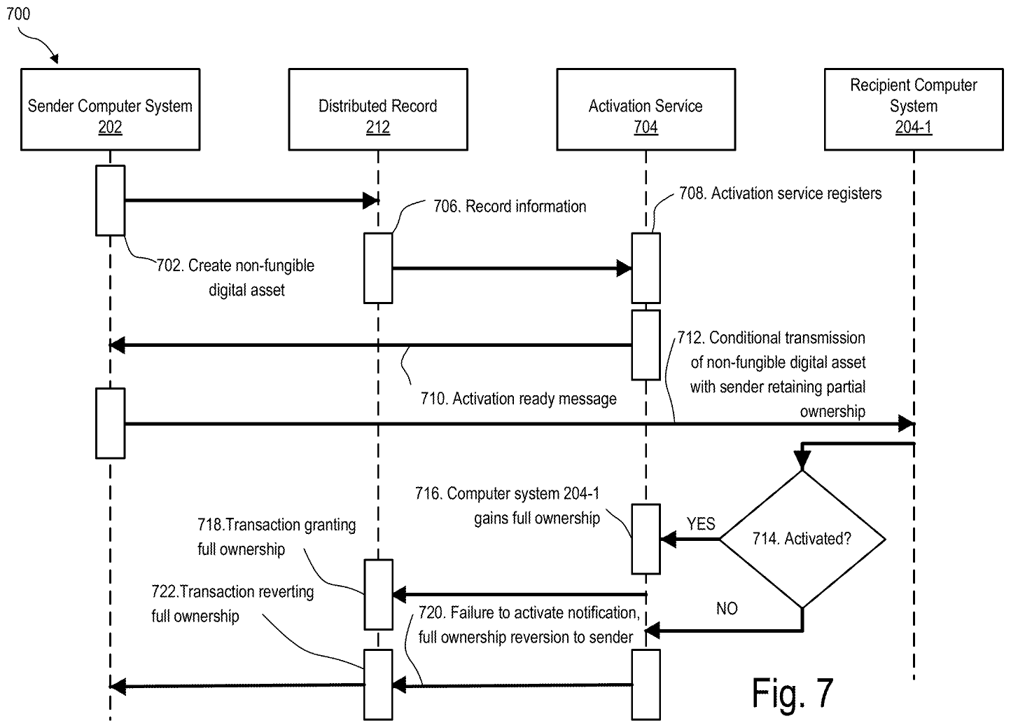

FIG. 7 is another exemplary flow diagram 700 that depicts exemplary operations that may be performed by system 100 to facilitate transfer of ownership of a non-fungible digital asset. As shown in FIG. 7, at operation 702, sender computer system 202 may create a non-fungible digital asset. The non-fungible digital asset may have an activation tag that is usable by an activation service 704 (which may be implemented in any suitable manner by system 100) to activate the non-fungible digital asset.

At operation 706, system 100 may record information in distributed record 212 associated with the non-fungible digital asset. Operation 706 may be performed in any suitable manner.

At operation 708, activation service 704 may register the non-fungible digital asset in any suitable manner.

At operation 710, activation service 704 may send an activation ready message to sender computer system 202. Operation 710 may be performed in any suitable manner.

At operation 712, sender computer system 202 may conditionally transmit the non-fungible digital asset to recipient computer system 204-1 while a user account associated with sender computer system 202 retains partial ownership of the non-fungible digital asset. Operation 712 may be performed in any suitable manner, such as described herein.

At operation 714, system 100 may determine whether the non-fungible digital asset has been activated (e.g., a predefined condition has been satisfied). Operation 714 may be performed in any suitable manner.

If the answer at operation 714, is “YES,” a user account associated with computer system 204-1 gains full ownership of the non-fungible digital asset at operation 716 and the transaction granting full ownership to the user account associated with computer system 204-1 is recorded in distributed record 212 at operation 718.

If the answer at operation 714 is “NO,” a failure to activate notification may be sent to sender computer system 202 at operation 720 and full ownership of the non-fungible digital asset reverts back to the user account associated with sender computer system 202.

At operation 722, system 100 may record in the distributed record 212 a transaction indicating that full ownership reverted back to sender computer system 202.

In certain implementations, the flow chart shown in FIG. 7 may also include a reclaim event where a user of sender computer system 202 may perform some action to reclaim the non-fungible digital asset after operation 720. For example, the user may be required to provide a user input by way of a user interface of sender computer system 202 to reclaim full ownership of the non-fungible digital asset. Alternatively, full ownership of the non-fungible digital asset may automatically revert back to the user account associated with sender computer system 202 if the answer at operation 714 is “NO.”

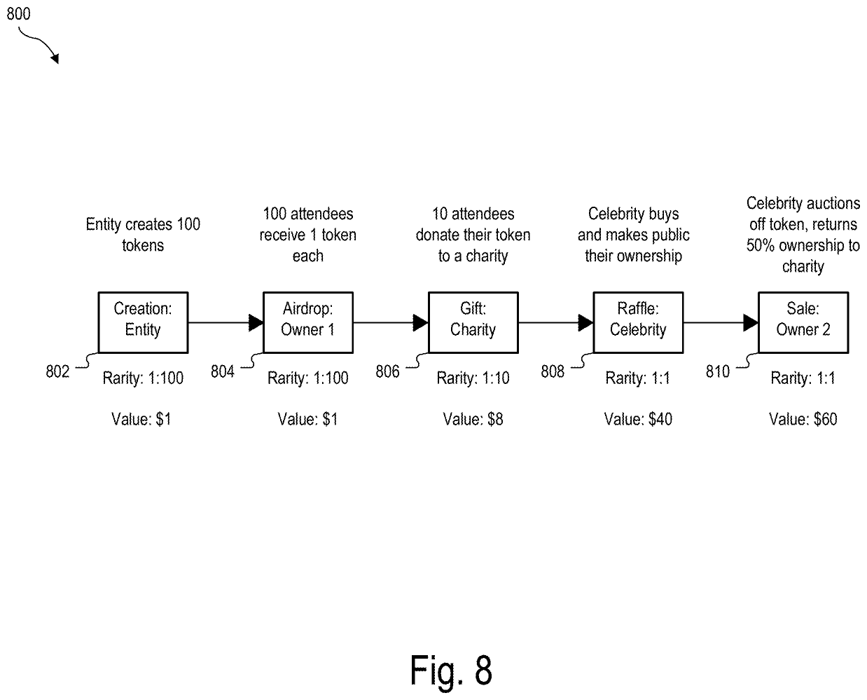

FIG. 8 is a flow diagram 800 that depicts exemplary operations that may be performed by system 100 in managing transfer and/or use of a non-fungible digital asset in the form of a token. In the example shown in FIG. 8 an entity may create one hundred tokens at operation 802. The tokens may correspond to digital memorabilia that is unique but there are one hundred of the same tokens created. In such an example, the tokens may have a rarity of 1:100 and a value of $1. The entity may airdrop the tokens such that one hundred attendees at an event receive one token each at operation 804. With such an airdrop, the tokens may still have a rarity of 1:100 and a value of $1.

Of the one hundred attendees, ten of the attendees may donate their token to a charity at operation 806. The donation of the token to the charity may change the rarity of the donated tokens to 1:10 and the value to $8.

A celebrity may then buy a token from the charity at operation 808 and offer the token in a celebrity auction. In certain examples, the token may be augmented by the celebrity in any suitable manner such as described herein (e.g., by combining a signature token with the token obtained from the charity). At operation 808, the rarity of the token is now 1:1 and the value has increased to $40.

At operation 810, the celebrity may sell the token (e.g., at a charity auction) to another party such that the rarity of the toke is 1:1 and the value is $60.

In certain examples, the celebrity may split ownership of the token such that the charity retains fractional ownership of the token. This may be accomplished in any suitable manner. For example, system 100 may implement a value share on trade function to implement the fractional ownership of the token by the charity. In certain examples, an ERC-1155 multi token protocol may be used to implement the fractional ownership of the token between the charity and the celebrity. After the token is sold at a charity auction, part of the value of the token returns to the charity. For example, if the charity owned fifty percent of the token, half of the charity auction sale price may revert back to the charity. In so doing, the increased value of the token may benefit the celebrity, the charity, and the owner of the token through the charity auction.

In certain implementations, owner class function 318 may define different asset ownership classes that may be associated with non-fungible digital assets such as those described herein. For example, such asset ownership classes may include, but are not limited to, a creator class, a general user class, a celebrity class, and a charity class. With the creator class, the creator is a user that mints the non-fungible digital asset. The creator may be a business, a franchise, or any other entity that wants to create and/or distribute non-fungible digital assets. The creator may certify the provenance (e.g., licensed content) of the non-fungible digital assets, create and distribute the non-fungible digital assets, donate the non-fungible digital assets (e.g., to charity), and facilitate augmentation (e.g., signing) of the non-fungible digital assets in any suitable manner, such as described herein.

With the general user class, the general user is the entity that is the primary owner of the non-fungible digital asset. The general user is the one that collects non-fungible digital assets (e.g., as digital collectable assets). The general user may, for example, trade a collected non-fungible digital asset, view the collected non-fungible digital asset, share the collected non-fungible digital asset, augment the collected non-fungible digital asset, and/or use any other suitable ownership function such as those described herein with respect to the collected non-fungible digital asset.

With the celebrity class, the celebrity is a user that mints celebrity non-fungible digital assets (e.g., signature tokens) and certifies the provenance of them. The celebrity may have the ability to, for example, use the celebrity non-fungible digital assets to augment (e.g., sign) other non-fungible digital assets provided from a general user or a creator in any suitable manner, such as described herein.

With the charity class, the charity is an entity that may view assets and/or metadata from a donated non-fungible digital asset. In certain examples, the charity may be able to keep all or part of the proceeds from a sale of a non-fungible digital asset if, for example, a donor (e.g., a general user or creator) sells the non-fungible digital asset. However, the charity may not be able to independently sell the donated non-fungible digital asset.

In certain examples, system 100 may collect analytics information associated with use of digital assets. Such analytics information may include anonymous data from digital asset transactions performed according to principles described herein. The analytics information may be used in any suitable manner as may serve a particular implementation. For example, the collected analytics information may be used to provide advertisements to users, evaluate the effectiveness of promotional items, track popularity of digital assets, evaluate sponsorships, evaluate charitable contributions, and/or for any other suitable purpose.

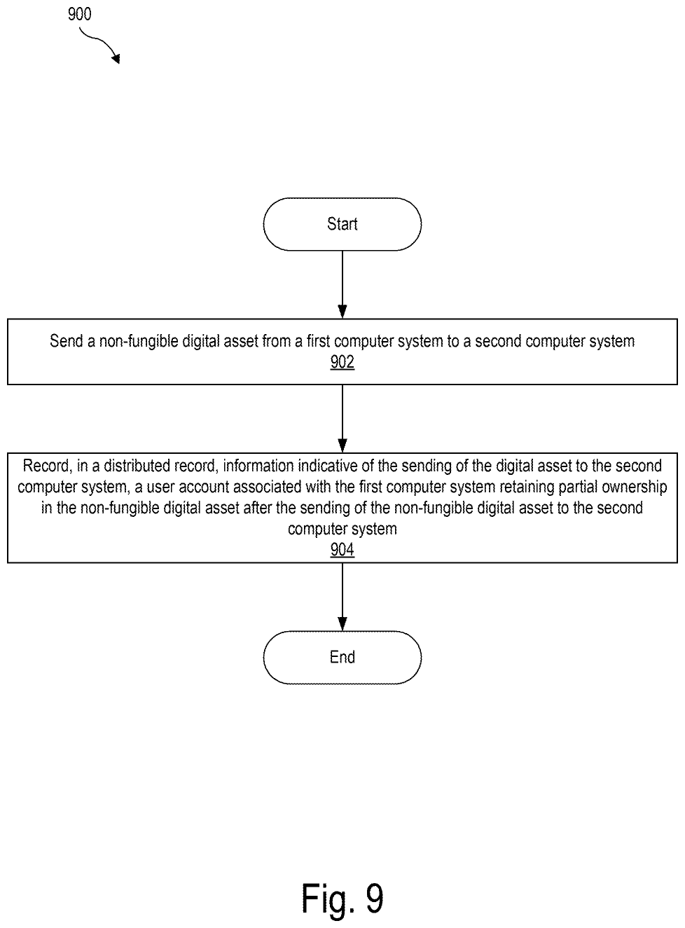

FIG. 9 illustrates an exemplary method for digital asset management. While FIG. 9 illustrates exemplary operations according to one embodiment, other embodiments may omit, add to, reorder, and/or modify any of the operations shown in FIG. 9. One or more of the operations shown in FIG. 9 may be performed by system 100, any components included therein, and/or any implementation thereof.

At operation 902, a digital asset management system (e.g., digital asset management system 100) may send a non-fungible digital asset from a first computer system to a second computer system. The first computer system and the second computer system may be included in a plurality of computer systems configured to form a distributed record configured to track ownership of non-fungible digital assets. Operation 902 may be performed in any of the ways described herein.

At operation 904, the digital asset management system may record, in the distributed record, information indicative of the sending of the non-fungible digital asset to the second computer system. Operation 904 may be performed in any of the ways described herein.

As described herein, a user account associated with the first computer system may retain partial ownership of the non-fungible digital asset after the sending of the non-fungible digital asset to the second computer system.

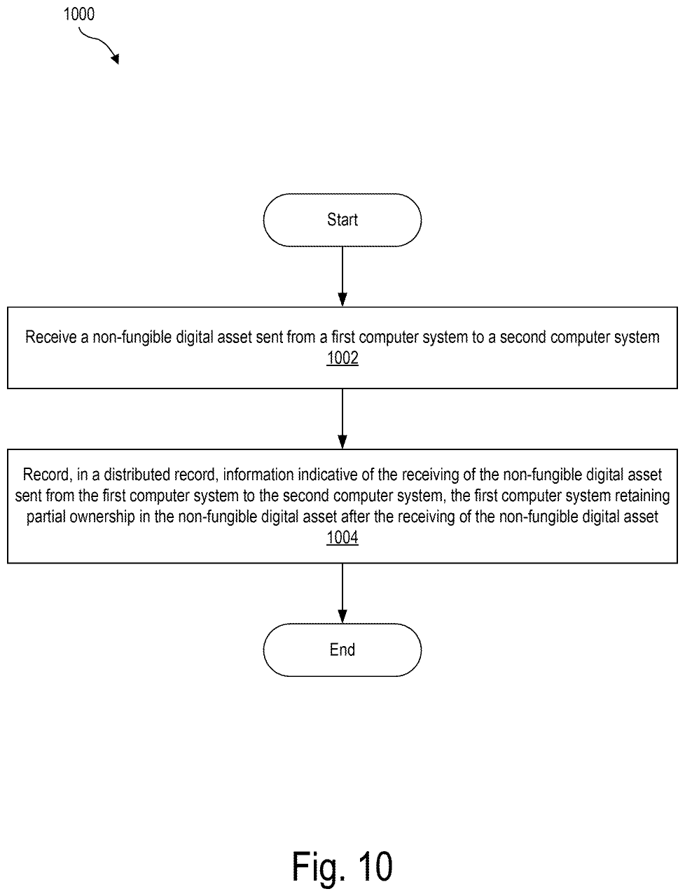

FIG. 10 illustrates another exemplary method for digital asset management. While FIG. 10 illustrates exemplary operations according to one embodiment, other embodiments may omit, add to, reorder, and/or modify any of the operations shown in FIG. 10. One or more of the operations shown in FIG. 10 may be performed by system 100, any components included therein, and/or any implementation thereof.

At operation 1002, a digital asset management reality system (e.g., digital asset management system 100) may receive a non-fungible digital asset sent from a first computer system to a second computer system. As described herein, the first computer system and the second computer system are included in a plurality of computer systems configured to form a distributed record configured to track ownership of non-fungible digital assets. Operation 1002 may be performed in any of the ways described herein.

At operation 1004, the digital asset management system may record, in the distributed record, information indicative of the receiving of the non-fungible digital asset sent from the first computer system to the second computer system. Operation 1004 may be performed in any of the ways described herein.

A user account associated with the first computer system retains partial ownership in the non-fungible digital asset after the receiving of the non-fungible digital asset by the digital asset management system.

Although the preceding disclosure primarily describes systems and methods for managing transfer of ownership, sharing of ownership, etc. of a non-fungible digital asset, it is understood that certain principles and concepts described herein may also be applied to manage use and/or transfer of ownership of certain fungible digital assets. For example, systems and methods such as those described herein may be used to facilitate airdropping a fungible cryptocurrency (e.g., a cryptocurrency token or coin) to a user account associated with a computer system in any suitable manner such as described herein.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g. a hard disk, a floppy disk, magnetic tape, etc.), ferroelectric random-access memory (RAM), and an optical disc (e.g., a compact disc, a digital video disc, a Blu-ray disc, etc.). Exemplary volatile storage media include, but are not limited to, RAM (e.g., dynamic RAM).

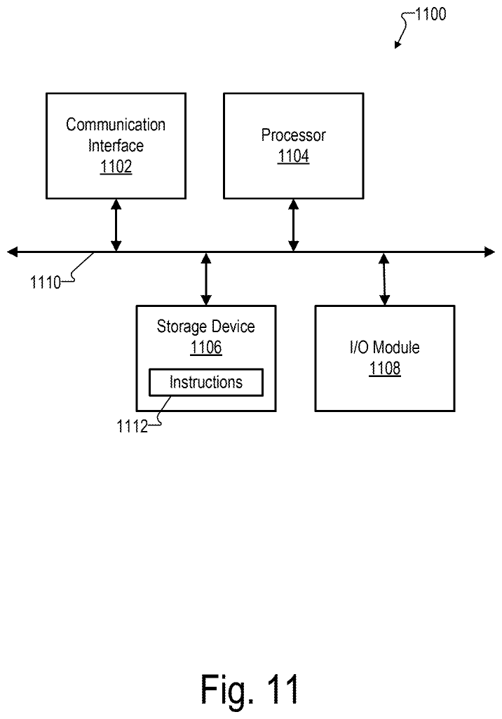

FIG. 11 illustrates an exemplary computing device 1100 that may be specifically configured to perform one or more of the processes described herein. As shown in FIG. 11, computing device 1100 may include a communication interface 1102, a processor 1104, a storage device 1106, and an input/output (I/O) module 1108 communicatively connected one to another via a communication infrastructure 1110. While an exemplary computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, an audio/video connection, and any other suitable interface.

Processor 1104 generally represents any type or form of processing unit capable of processing data and/or interpreting, executing, and/or directing execution of one or more of the instructions, processes, and/or operations described herein. Processor 1104 may perform operations by executing computer-executable instructions 1112 (e.g., an application, software, code, and/or other executable data instance) stored in storage device 1106.

Storage device 1106 may include one or more data storage media, devices, or configurations and may employ any type, form, and combination of data storage media and/or device. For example, storage device 1106 may include, but is not limited to, any combination of the non-volatile media and/or volatile media described herein. Electronic data, including data described herein, may be temporarily and/or permanently stored in storage device 1106. For example, data representative of computer-executable instructions 1112 configured to direct processor 1104 to perform any of the operations described herein may be stored within storage device 1106. In some examples, data may be arranged in one or more databases residing within storage device 1106.

I/O module 1108 may include one or more I/O modules configured to receive user input and provide user output. One or more I/O modules may be used to receive input for a virtual experience. I/O module 1108 may include any hardware, firmware, software, or combination thereof supportive of input and output capabilities. For example, I/O module 1108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 1100. For example, memory 102 may be implemented by storage device 1106, and processor 104 may be implemented by processor 1104.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
sending, by a digital asset management system, a non-fungible digital asset from a first computer system to a second computer system, wherein the first computer system and the second computer system are included in a plurality of computer systems configured to form a distributed record configured to track ownership of non-fungible digital assets; and
recording, by the digital asset management system in the distributed record, information indicative of the sending of the non-fungible digital asset to the second computer system,
wherein a user account associated with the first computer system retains partial ownership in the non-fungible digital asset after the sending of the non-fungible digital asset to the second computer system.

2. The method of claim 1, wherein the non-fungible digital asset is subject to a digital asset specification that defines a plurality of ownership functions associated with the non-fungible digital asset.

3. The method of claim 2, wherein:
the plurality of ownership functions includes a reclaim function specifying that full ownership of the non-fungible digital asset reverts to the user account associated with the first computer system upon satisfaction of a predefined condition; and
the method further comprises receiving, by the digital asset management system, the non-fungible digital asset from the second computer system upon satisfaction of the predefined condition such that the user account associated with the first computer system has full ownership of the non-fungible digital asset.

4. The method of claim 3, wherein the predefined condition includes expiration of a predefined time period in which a user of the second computer system is required to accept receipt of the non-fungible digital asset.

5. The method of claim 1, wherein the recording of the information in the distributed record includes recording that the user account associated with the first computer system owns a first part of the non-fungible digital asset and an additional user account associated with the second computer system owns a second part of the non-fungible digital asset.

6. The method of claim 5, wherein while the user account associated with the first computer system owns the first part of the non-fungible digital asset and the additional user account associated with the second computer system owns the second part of the non-fungible digital asset, approval for transfer of ownership of the non-fungible digital asset to a third party is required by both a user of the first computer system and a user of the second computer system.

7. The method of claim 1, wherein the sending of the non-fungible digital asset to the second computer system comprises airdropping the non-fungible digital asset to an additional user account associated with the second computer system.

8. A method comprising:
receiving, by a digital asset management system, a non-fungible digital asset sent from a first computer system to a second computer system, wherein the first computer system and the second computer system are included in a plurality of computer systems configured to form a distributed record configured to track ownership of non-fungible digital assets; and
recording, by the digital asset management system in the distributed record, information indicative of the receiving of the non-fungible digital asset sent from the first computer system to the second computer system,
wherein a user account associated with the first computer system retains partial ownership in the non-fungible digital asset after the receiving of the non-fungible digital asset by the digital asset management system.

9. The method of claim 8, wherein the non-fungible digital asset is subject to a digital asset specification that defines a plurality of ownership functions associated with the non-fungible digital asset.

10. The method of claim 9, wherein the plurality of ownership functions includes an ownership transfer function specifying that full ownership of the non-fungible digital asset is transferred to an additional user account associated with the second computer system upon satisfaction of a predefined condition.

11. The method of claim 10, wherein:
the predefined condition includes acceptance of receipt of the non-fungible digital asset; and
the method further comprises:
detecting, by the digital asset management system, user input accepting receipt of the non-fungible digital asset; and
instructing, by the digital asset management system in response to the detecting of the user input, the additional user account associated with the second computer system to receive full ownership of the non-fungible digital asset.

12. The method of claim 9, wherein:
the plurality of ownership functions includes a share function specifying one or more usage restrictions of the non-fungible digital asset while shared with a third computer system; and
the method further comprises sharing, by the digital asset management system, the non-fungible digital asset with the third computer system.

13. The method of claim 12, wherein the one or more usage restrictions include restricting the third computer system from changing ownership of the non-fungible digital asset.

14. The method of claim 9, wherein the plurality of ownership functions includes an augment function specifying one or more augmentation restrictions associated with an augmentation of the non-fungible digital asset by a user of a third computer system.

15. The method of claim 14, further comprising:
sending, by the digital asset management system, the non-fungible digital asset to the third computer system; and
receiving, by the digital asset management system from the third computer system, an augmented non-fungible digital asset that includes the non-fungible digital asset and the augmentation.

16. The method of claim 14, wherein the augmentation of the non-fungible digital asset includes combining a semi-fungible digital asset with the non-fungible digital asset.

17. The method of claim 14, wherein the augmentation of the non-fungible digital asset includes a digital signature of the user of the third computer system combined with the non-fungible digital asset.

18. A system comprising:
a memory that stores instructions; and
a processor communicatively coupled to the memory and configured to execute the instructions to send a non-fungible digital asset from a first computer system to a second computer system,
wherein
the first computer system and the second computer system are included in a plurality of computer systems configured to form a distributed record configured to track ownership of non-fungible digital assets, and
a user account associated with the first computer system retains partial ownership in the non-fungible digital asset after the sending of the non-fungible digital asset to the second computer system.

19. The system of claim 18, wherein the non-fungible digital asset is subject to a digital asset specification that defines a plurality of ownership functions associated with the non-fungible digital asset.

20. The system of claim 19, wherein:
the plurality of ownership functions includes a reclaim function specifying that full ownership of the non-fungible digital asset reverts to the first computer system upon satisfaction of a predefined condition; and
the processor is further configured to execute the instructions to direct the second computer system receive the non-fungible digital asset from the first computer system upon satisfaction of the predefined condition such that the second computer system has full ownership of the non-fungible digital asset.
